(19) United States
(12) Patent Application Publication
(10) Pub. No.: US 2013/0147104 A1
(43) Pub. Date: Jun. 13, 2013

(54) PENCIL SHARPENER

(71) Applicant: Takeshi Saito, Katsushika-ku (JP)

(72) Inventor: Takeshi Saito, Katsushika-ku (JP)

(73) Assignee: CARL MFG. CO., LTD., Tokyo (JP)

(21) Appl. No.: 13/818,752

(22) PCT Filed: Jul. 28, 2011
(86) PCT No.: PCT/JP2011/067223

§ 371 Date: Feb. 25, 2013

(30) Foreign Application Priority Data
Aug. 30, 2010 (JP) 2010-192997

(51) Int. Cl. B43L 23/00

(52) U.S. Cl. CPC B43L 23/008
USPC 269/218

(57) ABSTRACT

A pencil sharpener that has a strong clamping force, does not leave marks on the surface of the pencil due to clamping, and is easy to manufacture. The pencil sharpener includes a housing having a pencil insertion hole and a plurality of pivot parts arranged in a concentric circle around the pencil insertion hole, a frame body having a plurality of arc-shaped grooves, and a plurality of cam-shaped members that are pivotably attached to the pivot parts. When the frame body pivots, the cam-shaped members relatively move while being guided by the grooves, and their distal ends swing in a direction in which they move closer to or away from an insertion hole, and thereby a pencil that has been inserted is fixed or released.

### TECHNICAL FIELD

The present invention relates to a pencil sharpener used by mounting on a desk, and in particular to a pencil sharpener including a chuck mechanism for clamping a pencil that has been inserted.

### BACKGROUND ART

An electric or manual pencil sharpener used by mounting on a desk has a structure in which a chuck part for fixing a pencil that has been inserted and a cutting part that sharpens the pencil that has been fixed are disposed on an axis line. By moving the cutting part while rotating it around the pencil, the circumferential side surface of the pencil is sharpened and the core is formed into a point.

As a chuck part of such a pencil sharpener, Japanese Patent Application Laid-Open (JP-A) No. 2008-23753 discloses an invention in which a ring-shaped spring member that is biased in a reduced diameter direction is mounted around an outer circumference of a rubber ring member. When a pencil is inserted while operating opening/closing operating pieces provided on both ends in an enlarged diameter direction, the pencil that has been inserted into the ring member is fixed.

In addition, Japanese Patent Application National Publication No. 2001-526139 proposes a chuck mechanism in which a pencil that has been inserted is clamped and fixed coaxially relative to the center axis line of the pencil by a plurality of retaining tongue pieces arranged in a radial direction.

In this chuck mechanism, the retaining tongue pieces are swingably attached in a spring biased state at 3 locations within a frame body for retaining the pencil. When the frame body is pivoted centered on the axis line of the pencil, the retaining tongue pieces deform from a position at which they clamp the pencil to a position at which they are opened by pivoting movement opposing the spring pressure.

The retaining tongue pieces can be opened in order to insert a pencil by pinching a fixed operating part provided on a top end of a housing including a pencil insertion hole and a movable operating part provided on a top end of the frame body with a hand to bring them together and then pivoting the frame body.

When a pencil is inserted between the opened retaining tongue pieces and both operating pieces are released, the distal ends of the retaining tongue pieces swing toward the center axis line of the pencil to clamp the pencil that has been inserted.

### CITATION LIST

### Patent Literature

Patent Literature 1: Japanese Patent Application Laid-Open No. 2008-23753

Patent Literature 2: Japanese Patent Application National Publication No. 2001-526139

### SUMMARY OF INVENTION

### Technical Problem

However, in the chuck part in JP-A No. 2008-23753, the rubber ring member is interposed and the entire circumference of a pencil is clamped with the ring-shaped spring member. Thus, the compressive force acting on the circumferential side surface of the pencil is made uniform and the clamping force becomes relatively weak. Further, the compressive force decreases due to friction of the rubber ring member, and this can may lead to cases in which the pencil is rotated along with the rotation of the cutting part.

The chuck mechanism of Japanese Patent Application National Publication No. 2001-526139 has a strong clamping force, but clamping marks due to unevenness of the distal ends of the retaining tongue pieces may remain as dents on the circumferential side surface of the pencil. Further, it is necessary to bias each of the retaining tongue pieces with a spring force that can enable the clamping of the pencil, and thus the structure becomes complex and the manufacturing becomes complicated.

Thus, an object of the present invention is to provide a pencil sharpener that has a strong clamping force, does not leave marks on the surface of the pencil due to clamping, and is easy to manufacture.

### Solution to Problem

In order to solve the above problems, the pencil sharpener of the present invention comprises: a chuck part for fixing a pencil that has been inserted; a housing including a pencil insertion hole, a plurality of pivot parts arranged at the same distance from the pencil insertion hole, and a fixed operating part for performing a fixing operation of the pencil; a frame body including a movable operating part that has an insertion hole which can communicate with the pencil insertion hole and performs a fixing operation of the pencil together with the fixed operating part, and a plurality of arc-shaped grooves at locations corresponding to the pivot parts; and a plurality of cam-shaped members that are attached to the pivot parts at pivot support parts and have elastic members attached to their distal ends. The plurality of cam-shaped members swing in a direction in which the elastic members move close to or away from the insertion hole by pivoting centered on the pivot support parts. Further, by bringing the movable operating part and the fixed operating part close to each other, the frame body pivots centered on the insertion hole and the frame body is biased so that the pivot support parts relatively move while being guided by the grooves and the distal ends of the cam-shaped members swing in a direction in which the distal ends secede from the insertion hole.

### Advantageous Effects of Invention

The pencil sharpener according to the present invention includes a chuck part for fixing a pencil that has been inserted, a housing having a plurality of pivot parts arranged at the same distance from a pencil insertion hole, a frame body in which a plurality of arc-shaped grooves are provided at locations corresponding to the pivot parts, and cam-shaped members that are guided by the grooves and move relatively within the grooves. By bringing a movable operating part provided on the frame body close to a fixed operating part provided on the housing, the frame body pivots and the cam-shaped members rotate eccentrically centered on the pivot parts. Thereby, a mechanism for swinging the distal ends of the cam-shaped members closer to or away from the insertion hole can be realized with a simple structure.

Accordingly, a chuck part with good clamping performance can be manufactured without increasing the design precision, and the manufacturing process can be simplified. Further, since the pencil that has been inserted into the insertion hole is clamped via elastic members on the distal ends of the cam-shaped members, clamping marks can be prevented from remaining as dents on the surface of the pencil.

### BRIEF DESCRIPTION OF DRAWINGS

FIG. 1 is a perspective view illustrating a pencil sharpener according to an embodiment of the present invention.

FIG. 2 is a disassembled perspective view illustrating the internal structure of the pencil sharpener.

FIG. 3 shows cross-section views of the essential parts illustrating the structure of a chuck part of the pencil sharpener, and FIG. 3(a) illustrates an initial state and FIG. 3(b) illustrate a state in which the chuck is opened.

FIG. 4 illustrates a cam-shaped member before and after mounting a rubber member, and FIG. 4(a) is a front view, FIG. 4(b) is a cross-section view along the line indicated by arrows A-A, and FIG. 4(c) is a plan view.

### DESCRIPTION OF EMBODIMENTS

Preferred embodiments of the present invention will be explained below referring to the attached drawings. The embodiments of the present invention are not limited to the following embodiments, and other embodiments are possible as long as they can solve the problem of the present invention.

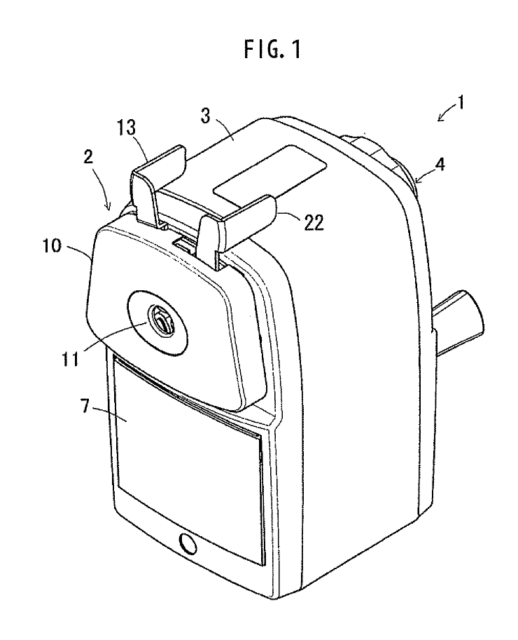

FIG. 1 is a perspective view illustrating a pencil sharpener 1 according to the present invention.

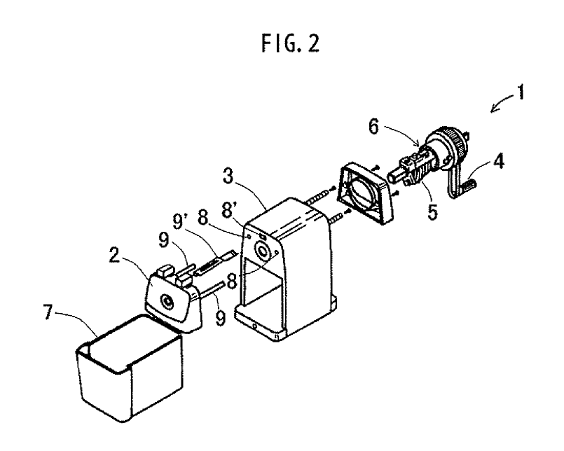

The pencil sharpener 1 is a manual-type pencil sharpener used by mounting on a desk, in which a chuck part 2 for fixing a pencil that has been inserted is attached to a front surface of a main body housing 3 so that it can be pulled out and an operating handle 4 is attached to a rear surface of the main body housing 3 (refer to FIG. 2).

Inside the main body housing 3, a cutting part 5 for sharpening the pencil that has been fixed by the chuck part 2 and a rotation mechanism 6 for moving the cutting part 5 to rotate it around the pencil are provided. A shavings box 7 for receiving the cut shavings is installed so that it can be pulled out below the cutting part 5 and the rotation mechanism 6.

From the front surface side of the pencil sharpener 1 into which a pencil is inserted, the chuck part 2, the cutting part 5, the rotation mechanism 6, and the operating handle 4 are arranged in order on an axis.

The structure of the chuck part 2 of the pencil sharpener 1 will be described in detail below.

The chuck part 2 is an area for fixing a pencil that has been inserted, and is attached so that it can be pulled out by inserting attachment shafts 9 into a plurality of attachment holes 8 provided on the front surface of the main body housing 3.

One of the attachment shafts 9 is a chuck stopper for fixing the chuck part 2 that is biased toward the main body housing 3 in a pulled out position, and is provided with a bent part 9′ for locking to a periphery of an attachment hole 8′ of the main body housing 3.

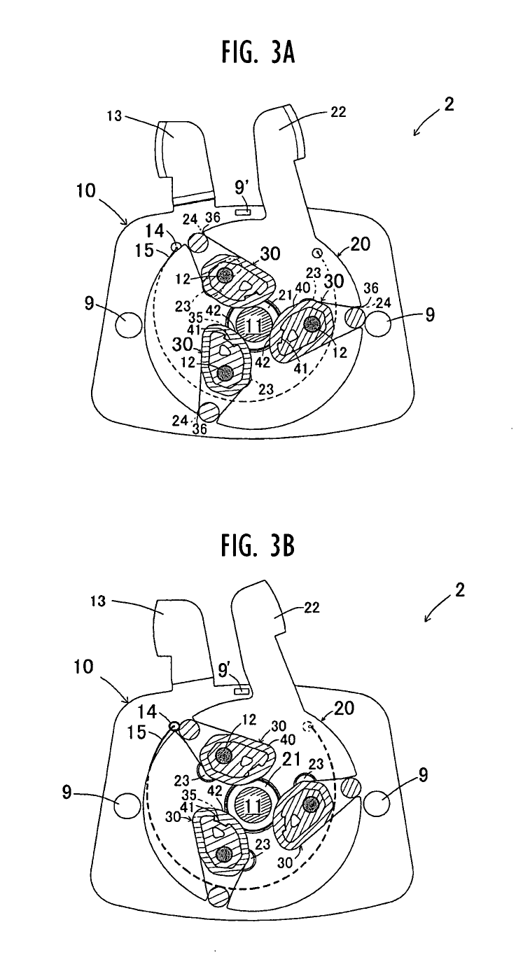

The chuck part 2 is configured to accommodate a frame body 20 and a plurality of cam-shaped members 30 in a chuck housing 10 that allows the attachment shafts 9 to project toward the rear surface side (refer to FIG. 3).

The chuck housing 10 is in a state in which it is attached to the main body housing 3 via the attachment shafts 9. A pencil insertion hole 11 is provided in the center of the chuck housing 10, and a plurality of pivot parts 12 are arranged in a concentric circle around the pencil insertion hole 11. On the top end, a fixed operating part 13 is provided for performing a fixing operation of the pencil while the chuck housing 10 is pulled out from the main body housing 3.

A small hole 14 is provided near the fixed operating part 13, and a frame body 20 is rotatably attached to the chuck housing 10 via a linear spring member 15 which has been inserted into the small hole 14.

The frame body 20 includes an insertion hole 21 in its center that can communicate with the pencil insertion hole 11 of the chuck housing 10. On the outer periphery of the frame body 20, a movable operating part 22 is provided for performing a fixing operation of the pencil together with the fixed operating part 13.

Arc-shaped grooves 23 are provided at 3 locations around the insertion hole 21 at the center. The grooves 23 are arranged at equal intervals at positions that are spaced the same distance apart from the insertion hole 21. The pivot parts 12 provided on the rear surface of the chuck housing 10 are inserted into the grooves 23.

The cam-shaped members 30 are pivotably attached to the respective pivot parts 12 of the chuck housing 10 via pivot support holes 31.

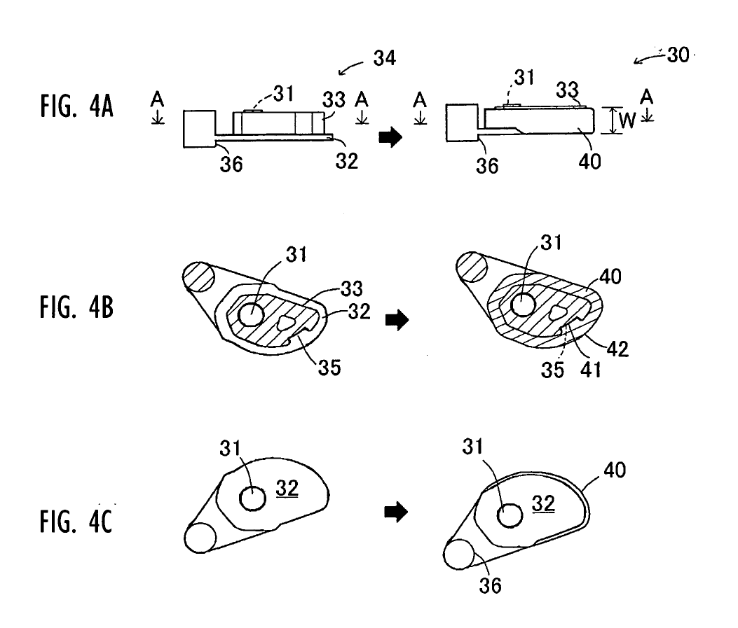

As shown in FIG. 4, each cam-shaped member 30 is constituted by attaching a rubber member 40 to a distal end of a base member 34 consisting of a cylinder part 33 arranged upright on cam-shaped flat surface 32.

Basically, the base member 34 is constituted by providing the pivot support hole 31 in the center, and then providing the cylinder part 33 for shaping the pivot support hole 31 on the flat surface 32 that extends perpendicular relative to the pivot support hole 31. On the outer periphery of the cylinder part 33, the ring-shaped rubber member 40 is attached, and thereby the cam-shaped member 30 is formed.

The base member 34 is made of synthetic resin, and a recessed part 35 is provided on the circumferential side surface of the cylinder part 33.

Meanwhile, the rubber member 40 has a protruding part 41 on its inner circumferential surface, and the rubber member 40 is attached to the base member 34 so that it does not come off by fitting the protruding part 41 into the recessed part 35 of the cylinder part 33.

The protruding part 41 of the rubber member 40 is made by increasing the thickness of the rubber material toward the inside. A width Win a distal end region including this thick part (41) is designed to be wider than the width in other regions.

The recessed part 35 of the base member 34 is provided at a position that comes closest to the pencil insertion hole 11 of the frame body 20 when the cam-shaped member 30 swings centered on the pivot support hole 31. When the protruding part 41 of the rubber member 40 is fitted into the recessed part 35, the pencil is compressed at an outer circumferential surface 42 on the rear side of the protruding part 41 (refer to FIG. 3(a)).

The cam-shaped member 30 is swingably locked to a locked part 24 of the frame body 20 at a locking part 36 provided on a base end of the base member 34.

The linear spring member 15 inserted into the small hole 14 of the chuck housing 10 is designed in a curved state so as to surround the pencil insertion hole 11 and biases the frame body 20 in a direction in which the movable operating part 22 secedes from the fixed operating part 13 of the chuck housing 10.

From this state, by bringing the movable operating part 22 close to the fixed operating part 13, the frame body 20 pivots centered on the insertion hole 21 and the pivot parts 12 of the chuck housing 10 relatively move within the grooves 23 of the frame body 20. Thereby, the cam-shaped members 30 rotate eccentrically centered on the pivot parts 12 in a state in which the locking parts 36 are locked while slidingly contacting the frame body 20. Thus, the pencil that has been inserted into the pencil insertion hole 11 is compressed at the outer circumferential surfaces 42 of the rubber members 40 at the distal ends of the cam-shaped members 30 (refer to FIG. 3(b)).

The usage state of the pencil sharpener 1 described above will now be explained below.

First, while pinching the fixed operating part 13 and the movable operating part 22 together, the chuck part 2 is pulled out from the main body housing 3. At this time, the spring member 15 that is interposed between the chuck housing 10 and the frame body 20 is elastically deformed, and the frame body 20 pivots.

Due to this pivoting, the pivot parts 12 of the chuck housing 10 slide within the grooves 23 of the frame body 20 while being guided by the grooves 23. Due to the sliding of the pivot parts 12, the cam-shaped members 30 rotate eccentrically around the pivot support parts 31 as an axis. The distal end surfaces (42) of the rubber members 40 then secede from the center of the pencil insertion hole 11 and the chuck is opened.

In this state, a pencil is inserted into the pencil insertion hole 11, and then the movable operating part 22 is released in a state in which the tip of the pencil is pressed against the cutting part 5 within the main body housing 3.

When the movable operating part 22 is released, the frame body 20 rotates toward its original position by the elastic deformation of the linear spring member 15 (refer to FIG. 3(a)). Due to this rotation, the pivot parts 12 of the chuck housing 10 relatively move while being guided by the grooves 23. Due to the eccentric rotation of the cam-shaped members 30 caused by the relative movement of the pivot parts 12, the distal ends (42) of the cam-shaped members 30 swing in a direction in which they approach the center of the pencil insertion hole 11, and thus the pencil that has been inserted is clamped from a plurality of directions.

In the chuck part 2 of the present embodiment, the frame body 20 including the arc-shaped grooves 23 at positions corresponding to the pivot parts 12 is accommodated within the chuck housing 10 having the plurality of pivot parts 12 arranged at positions that are the same distance from the pencil insertion hole 11 in a state in which the frame body 20 is biased via the linear spring member 15, and the pivot support parts 31 of the cam-shaped member 30 are guided by the grooves 23 due to the pivoting of the frame body 20 and thus the pivot support parts 31 move relatively. Thereby, the cam-shaped members 30 rotate eccentrically around the pivot support parts 31 as an axis. Therefore, a mechanism for swinging the distal ends of the cam-shaped members 30 closer to or away from the insertion hole 21 is realized with a simple structure.

In particular, since the pencil is clamped via the rubber members 40 at the distal ends of the cam-shaped members 30, clamping marks can be prevented from remaining as dents on the surface of the pencil.

Further, since the linear spring member 15 is disposed between the chuck housing 10 and the frame body 20 in a curved state so as to surround the pencil insertion hole 11, a mechanism in which the frame body 20 is pivoted by bringing the movable operating part 22 and the fixed operating part 13 close to each other to swing the cam-shaped members 30 and clamp the pencil that has been inserted into the pencil insertion hole 11 can be realized with a simple structure.

Also, since the cylinder part 33 is provided in each cam-shaped member 30 and the ring-shaped rubber member 40 is mounted on the cylinder part 33, the rubber member 40 can be securely attached to the distal end of the cam-shaped member 30.

In particular, since the recessed part 35 is provided in the cylinder part 33 of each cam-shaped member 30, the protruding part 41 that can fit into the recessed part 35 is provided on the inner circumferential surface of the rubber member 40, and the pencil is compressed at the outer circumferential surfaces 42 on the rear side of the protruding parts 41 by the swinging of the cam-shaped members 30, the pencil can be compressed with a strong force. Further, the rubber members 40 can be prevented from coming off of the cylinder parts 33 when compressing the pencil with a strong force.

In addition, since the protruding part 41 that fits into the recessed part 35 of the base member 34 is formed by increasing the thickness of the rubber member 40 at the area that abuts the pencil, it is easy to design the elastic force of the cam-shaped members 30 so as to exert an appropriate compressive force on the pencil.

Further, since the width W in a distal end region including the protruding part is wider than the width in other regions, the pencil can be retained stably and with a strong force.

The pencil sharpener of the present invention can also be an electric-type.

The number and shape of the cam-shaped members in the chuck part can be appropriately modified so that the pencil can be clamped and fixed coaxially relative to the center axis line of the pencil from a plurality of directions.

The rubber members provided on the distal ends of the cam-shaped members can be made of any material as long as it is an elastic material, and the shape of the rubber members is not limited to a ring shape.

In the present embodiment, the protruding parts of the elastic members were formed integrally and of the same material with the ring-shaped rubber members 40, but the protruding parts can be made by joining a separate member.

### INDUSTRIAL APPLICABILITY

The present invention is not limited to the industrial field of office supplies for sharpening writing instruments, and it can be utilized as a device for sharpening the distal end of long objects in any industrial field, such as in the field of cosmetics as a pencil sharpener for sharpening eye pencils and in the field of architecture as a pencil sharpener for sharpening a rod-shaped member to make a wedge or the like.

### REFERENCE SIGNS LIST

1: pencil sharpener
2: chuck part
3: main body housing
4: operating handle
5: cutting part
6: rotation mechanism
7: shavings box
8: attachment hole
9: attachment shaft
10: chuck housing
11: pencil insertion hole
12: pivot part
13: fixed operating part
14: small hole
15: spring member
20: frame body
21: insertion hole
22: movable operating part
23: groove
30: cam-member
31: pivot support hole (pivot support part)
32: flat surface
33: cylinder part
34: base member
35: recessed part
36: locking part
40: rubber member (elastic member)
41: protruding part
42: outer circumferential surface (distal end)

1. A pencil sharpener comprising:
a chuck part for fixing a pencil that has been inserted;
a housing including a pencil insertion hole, a plurality of pivot parts arranged at the same distance from the pencil insertion hole, and a fixed operating part for performing a fixing operation of the pencil;
a frame body including a movable operating part that has an insertion hole which can communicate with the pencil insertion hole and performs a fixing operation of the pencil together with the fixed operating part, and a plurality of arc-shaped grooves at locations corresponding to the pivot parts; and
a plurality of cam-shaped members that are attached to the pivot parts at pivot support parts and have elastic members attached to their distal ends, wherein the plurality of cam-shaped members swing in a direction in which the elastic members move close to or away from the insertion hole by pivoting centered on the pivot support parts;
wherein by bringing the movable operating part and the fixed operating part close to each other, the frame body pivots centered on the insertion hole and the frame body is biased so that the pivot support parts relatively move while being guided by the grooves and the distal ends of the cam-shaped members swing in a direction in which the distal ends secede from the insertion hole.

2. The pencil sharpener according to claim 1, wherein in each cam-shaped member, a cylinder part in which the pivot support part is formed at an inside opening and the elastic member is mounted around an outer circumferential surface is formed on a flat surface that extends in a direction perpendicular to the pivot support hole.

3. The pencil sharpener according to claim 2, wherein a recessed part is provided on an outer circumferential surface of each cylinder part, a protruding part that can fit into the recessed part is provided on an inner circumferential surface of each elastic member, and outer circumferential surfaces located at the protruding parts compress the pencil inserted into the insertion hole by the swinging of the cam-shaped members.

4. The pencil sharpener according to claim 3, wherein the protruding parts are formed on the elastic members at a thick part provided on the inner circumferential surface.

5. The pencil sharpener according to claim 4, wherein a width of a distal end region including the protruding part is wider than a width at other regions.
